(19) United States
(12) Patent Application Publication
(10) Pub. No.: US 2006/0045486 A1
(43) Pub. Date: Mar. 2, 2006

(54) Recording and reproducing device and recording and reproducing method

(75) Inventors: Kenichi Iida, Saitama (JP); Eiichi Yamada, Tokyo (JP); Izuru Tanaka, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/213,879

(22) Filed: Aug. 30, 2005

(30) Foreign Application Priority Data
Sep. 2, 2004 (JP) P2004-256202

(51) Int. Cl. H04N 5/76; H04N 5/225

(52) U.S. Cl. 386/95; 386/117

(57) ABSTRACT

A portable type recording and reproducing device including recording means for converting sound information obtained by collecting external sound to files in message units and recording the files on a predetermined recording medium, and recording image information obtained by photographing an outside on the recording medium in association with a corresponding file of sound information in response to a predetermined first external operation, display means for displaying images based on image information associated with respective files of sound information, and reproducing means for reproducing a file of sound information associated with an image selected by a predetermined second external operation among the images displayed by the display means. The recording means creates an image managing file for associating the sound information with each piece of image information, and the reproducing means reproduces the file of the sound information associated with the image selected by the predetermined second external operation among the images displayed by the display means on a basis of the image managing file.

### BACKGROUND OF THE INVENTION

The present invention relates to a recording and reproducing device and a recording and reproducing method, and is suitable for application to an IC (Integrated Circuit) recorder with a camera, for example.

Conventionally, there is an IC recorder as a portable type sound recording and reproducing device. This IC recorder collects external sound by a built-in microphone, subjects sound data obtained to a compression coding process, and records resulting data in a built-in semiconductor memory or an external memory such as a Memory Stick (a registered trademark of Sony Corporation) or the like loaded in the IC recorder.

Such an IC recorder has a small size and a light weight and is excellent in portability. Therefore, recently, the IC recorder has been used at meetings or in making arrangements, for example, on a business scene, and has also been widely used on other than the business scene as a sound memo device for personal use.

### SUMMARY OF THE INVENTION

Recently, incorporation of an image taking function in such an IC recorder has been proposed to record an image taken during sound recording in association with recorded sound (Japanese Patent Laid-Open No. 2004-134983).

In this case, according to Japanese Patent Laid-Open No. 2004-134983, link information for associating a sound file storing sound data obtained by sound recording with an image file storing image data obtained by photographing, or specifically link information such as the file name of an image file associated with sound data and a link time indicating a temporal position in the sound data of the image file is stored in a header part of the sound file and the image file. On the basis of this link information, a personal computer can recognize a correspondence between the sound file and the image file.

However, such a special format cannot maintain compatibility with sound files obtained by sound recording in an existing IC recorder. For example, even when sound files can be exchanged between the existing IC recorder and the IC recorder with a camera, the IC recorder with the camera cannot reproduce a sound file created by sound recording using the existing IC recorder and conversely the existing IC recorder cannot reproduce a sound file created by sound recording using the IC recorder with the camera.

The present invention has been made in view of the above point, and it is accordingly desirable to propose a recording and reproducing device and a recording and reproducing method that can associate sound files with image files while having versatility by maintaining compatibility with sound files obtained by sound recording using an existing recording and reproducing device.

According to an embodiment of the present invention, there is provided a portable type recording and reproducing device including: recording means for converting sound information obtained by collecting external sound to files in message units and recording the files on a predetermined recording medium, and recording image information obtained by photographing an outside on the recording medium in association with a corresponding file of sound information in response to a predetermined first external operation; display means for displaying images based on image information associated with respective files of sound information; and reproducing means for reproducing a file of sound information associated with an image selected by a predetermined second external operation among the images displayed by the display means. The recording means creates an image managing file for associating the sound information with each piece of image information, and the reproducing means reproduces the file of the sound information associated with the image selected by the predetermined second external operation among the images displayed by the display means on a basis of the image managing file.

As a result, this recording and reproducing device can associate a sound file with an image file using a file format employed in an existing recording and reproducing device as the file format of the file of sound information.

According to another embodiment of the present invention, there is provided a recording and reproducing method including: a first step of converting sound information obtained by collecting external sound to files in message units and recording the files on a predetermined recording medium, and recording image information obtained by photographing an outside on the recording medium in association with a corresponding file of sound information in response to a predetermined first external operation; a second step of displaying images based on image information associated with respective files of sound information; and a third step of reproducing a file of sound information associated with an image selected by a predetermined second external operation among the displayed images. In the second step, an image managing file for associating the sound information with each piece of image information is created. In the third step, the file of the sound information associated with the image selected by the predetermined second external operation among the displayed images is reproduced on a basis of the image managing file.

As a result, this recording and reproducing method can associate a sound file with an image file using a file format employed in an existing recording and reproducing device as the file format of the file of sound information.

According to the embodiments of the present invention, sound information obtained by collecting external sound is converted to files in message units and the files are recorded on a predetermined recording medium, image information obtained by photographing an outside is recorded on the recording medium in association with a corresponding file of sound information in response to a predetermined first external operation, images based on image information associated with respective files of sound information are displayed, and a file of sound information associated with an image selected by a predetermined second external operation among the displayed images is reproduced. When the image information is recorded on the recording medium in association with the corresponding file of the sound information, an image managing file for associating the sound information with each piece of image information is created. When the file of the sound information is reproduced, the file of the sound information associated with the image selected by the predetermined second external operation among the displayed images is reproduced on a basis of the image managing file. It is thereby possible to associate a sound file with an image file using the file format employed in an existing recording and reproducing device as the file format of the file of sound information. Thus, a recording and reproducing device and a recording and reproducing method can be realized which can associate a sound file with an image file while having versatility.

### BRIEF DESCRIPTION OF THE DRAWINGS

FIG. 1 is a perspective view of an external structure of an IC recorder with a camera according to a present embodiment when an LCD cover section is in a closed state;

FIG. 2 is a perspective view of an external structure of the IC recorder with the camera according to the present embodiment when the LCD cover section is in the closed state;

FIG. 3 is a perspective view of an external structure of the IC recorder with the camera according to the present embodiment when the LCD cover section is in an open state;

FIGS. 4A, 4B, and 4C are schematic diagrams of assistance in explaining rotational states of a camera cover;

FIG. 5 is a block diagram showing an internal configuration of the IC recorder with the camera according to the present embodiment;

FIG. 6 is a plan view of an outline of composition of a message folder selecting screen;

FIG. 7 is a conceptual diagram showing a directory structure of a Voiscape Format;

FIG. 8 is a conceptual diagram of assistance in explaining a data structure of a managing file;

FIG. 9 is a conceptual diagram of assistance in explaining a data structure of an image managing file;

FIG. 10 is a conceptual diagram showing a data structure of a header of an image managing file;

FIG. 11 is a conceptual diagram showing a data structure of a picture entry in the image managing file;

FIG. 12 is a flowchart of a selecting screen display process procedure;

FIG. 13 is a flowchart of a selecting screen display updating process procedure;

FIG. 14 is a flowchart of a sound reproduction process procedure;

FIG. 15 is a flowchart of a sound recording control process procedure;

FIG. 16 is a flowchart of selecting screen display process procedure; and

FIG. 17 is a flowchart of sound reproduction process procedure.

### DETAILED DESCRIPTION OF THE PREFERRED EMBODIMENT

One embodiment of the present invention will hereinafter be described in detail with reference to the drawings.

(1) Structure of IC Recorder 1 with Camera According to Present Embodiment

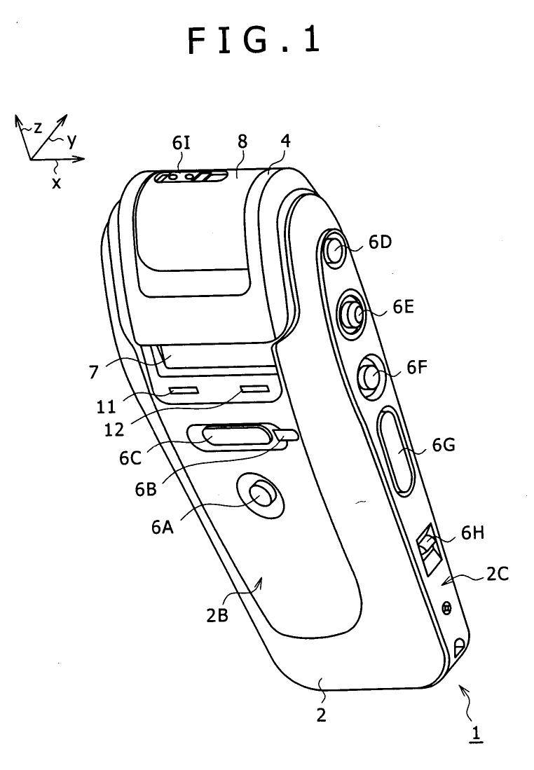

In FIGS. 1 to 3, reference numeral 1 denotes an IC recorder with a camera according to the present embodiment as a whole. An LCD cover section 4 to which a CCD (Charge Coupled Device) camera 3 is attached is disposed so as to be slidable in an upward direction (direction of an arrow z), on an upper part of a main body part 2 that is rounded as a whole and vertically long.

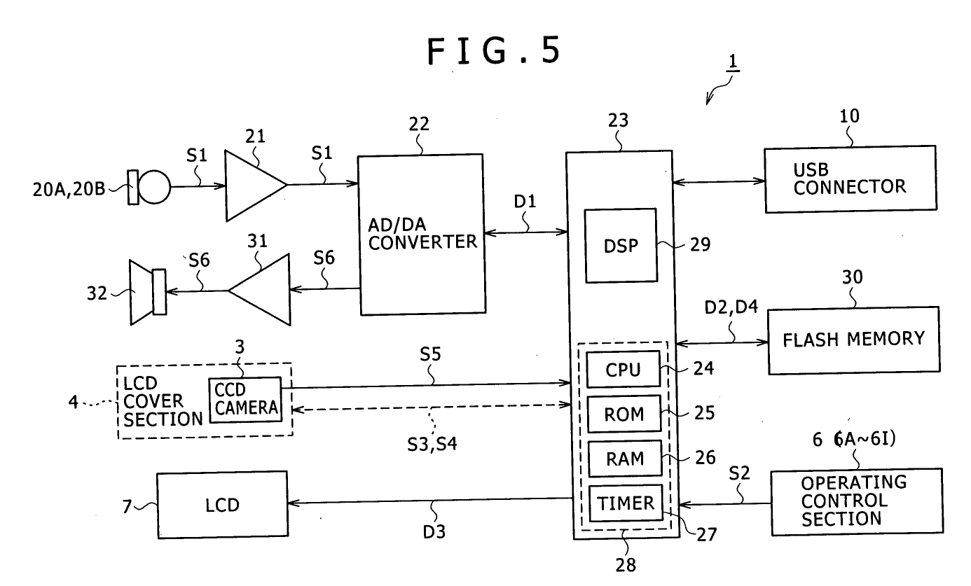

Sound collecting holes 5A and 5B are made on both a left side and a right side of an upper part of a back surface 2A of the main body part 2, and microphones 20A and 20B (FIG. 5) are housed within the main body part 2 in such a manner as to correspond to these sound collecting holes. Thus, these microphones 20A and 20B can collect external sound via the corresponding sound collecting holes 5A and 5B.

A recording button 6A is disposed at a middle position of a front surface 2B of the main body part 2. Pressing the recording button 6A can start an operation of recording the external sound collected by the microphones 20A and 20B.

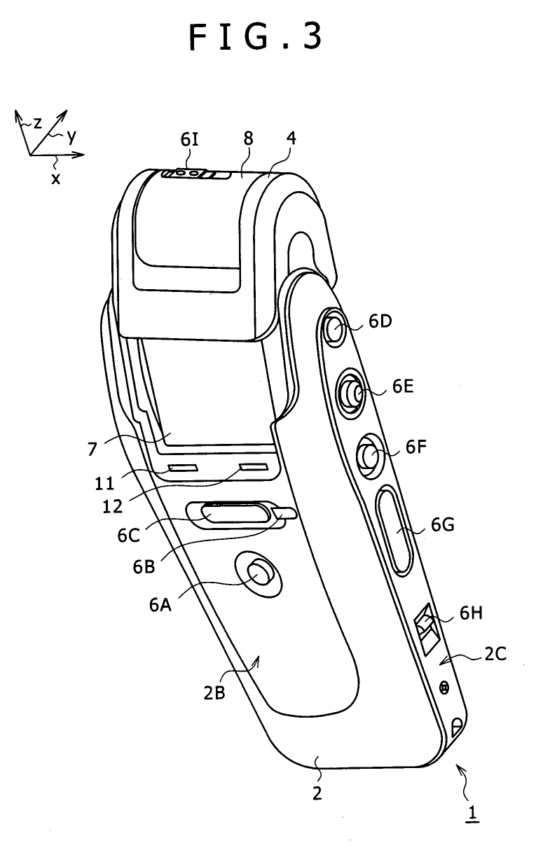

Further, an LCD 7 formed by a high-resolution color liquid crystal display is disposed at an upper position of the front surface 2B of the main body part 2, as shown in FIG. 3. A live view button 6B is disposed below the LCD 7. By pressing the live view button 6B when the LCD cover section 4 is set in an open state by being pulled out in the upward direction as shown in FIG. 3, and a camera cover 8 of the LCD cover section 4 is set in an open state by being rotated so as to expose the CCD camera 3 as later described, a moving image taken by the CCD camera 3 at that time can be displayed on the LCD 7.

A camera shutter button 6C is disposed on a left side of the live view button 6B at the middle position of the front surface 2B of the main body part 2. By pressing the camera shutter button 6C in a state of a moving image being displayed on the LCD 7, a still image for one frame at a moment when the camera shutter button 6C is pressed can be captured from the moving image displayed on the LCD 7, and stored. Thus, the IC recorder 1 with the camera makes it possible to record a desired still image while visually checking a moving image displayed on the LCD 7.

On the other hand, a menu button 6D is provided on a right side surface 2C of the main body part 2. By pressing the menu button 6D, a predetermined menu screen can be displayed on the LCD 7. In addition, a jog lever 6E is disposed under the menu button 6D on the right side surface 2C of the main body part 2. By operating the jog lever 6E such that the jog lever 6E is tilted in an upward direction, a downward direction, a left direction, or a right direction, or pressing the jog lever 6E, a desired alternative can be selected from among various alternatives displayed within a menu screen, or the alternative can be set as a selected object.

Further, a stop button 6F is disposed under the jog lever 6E on the right side surface 2C of the main body part 2, and a volume button 6G is disposed under the stop button 6F. Pressing the stop button 6F can stop recording operation or reproducing operation. Pressing an upper side or a lower side of the volume button 6G during reproducing operation can raise or lower the volume of reproduced sound output from a speaker 32 (FIG. 5) provided on the back side of the LCD 7 at this time.

Further, a voice-up switch 6H is disposed under the volume button 6G on the right side surface 2C of the main body part 2. When the voice-up switch 6H is set in an on state during reproducing operation, sound recorded at a low volume level can be output at a high volume level while the volume of sound recorded at a high volume level at the time of recording operation is maintained as it is.

On the other hand, a power supply connector 9 is disposed on a left side surface 2D of the main body part 2. By inserting a plug of a power supply kit into the power supply connector 9, power supply voltage can be supplied to the IC recorder 1 with the camera, or a battery not shown in the figure included in the IC recorder 1 with the camera can be charged.

In addition, a USB (Universal Serial Bus) connector 10 is disposed under the power supply connector 9 on the left side surface 2D of the main body part 2. The IC recorder 1 with the camera can be USB-connected to an external device such as a personal computer or the like via the USB connector 10. Thus, the IC recorder 1 with the camera can output sound data of recorded sound and image data of recorded images stored in the IC recorder 1 with the camera to the USB-connected external device, and capture sound data and image data supplied from the external device.

Incidentally, a charging LED (Light Emitting Diode) 11 illuminates at a time of charging and an operation LED 12 illuminating at a time of recording operation and at a time of reproducing operation are disposed directly below the LCD 7 on the front surface 2B of the main body part 2. Thus a user can easily detect whether charging, recording, and the like are surely performed on the basis of an on/off state of the charging LED 11 and the operation LED 12.

Further, a microphone jack 13 and a headphone jack 14 are disposed on a lower side surface 2E of the main body part 2. Thus, by inserting an output plug of an external microphone not shown in the figure into the microphone jack 13, external sound collected by the microphone can be captured and recorded. By inserting an external input plug of headphones not shown in the figure into the headphone jack 14, recorded sound reproduced at a time of reproducing operation can be listened to by the headphones.

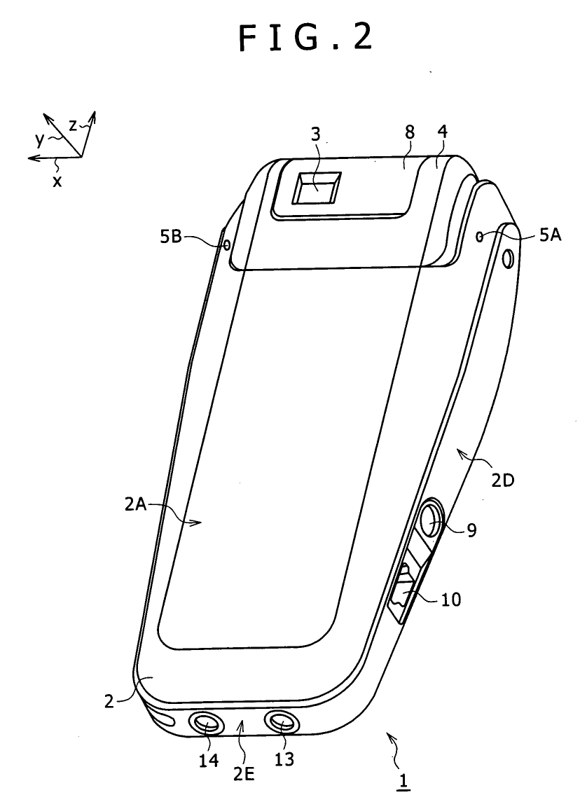

The external shape of the LCD cover section 4 is selected so as to cover about ⅔ of the LCD 7 of the main body part 2 in a closed state as shown in FIG. 1 and FIG. 2. Thereby, the IC recorder 1 with the camera when not used can protect the LCD 7 by the LCD cover section 4 by setting the LCD cover section 4 in the closed state, whereas the IC recorder 1 with the camera when used exposes the LCD 7 to allow a user to view a menu screen or the like displayed on the LCD 7 by pulling out the LCD cover section 4 in the upward direction and thereby setting the LCD cover section 4 in the open state as shown in FIG. 3.

A camera cover 8 in a cylindrical shape is rotatably disposed in an upper part of the LCD cover section 4, and the above-described CCD camera 3 is attached to a predetermined position of the camera cover 8 such that an optical axis of the CCD camera 3 is perpendicular to a central axis of the camera cover 8.

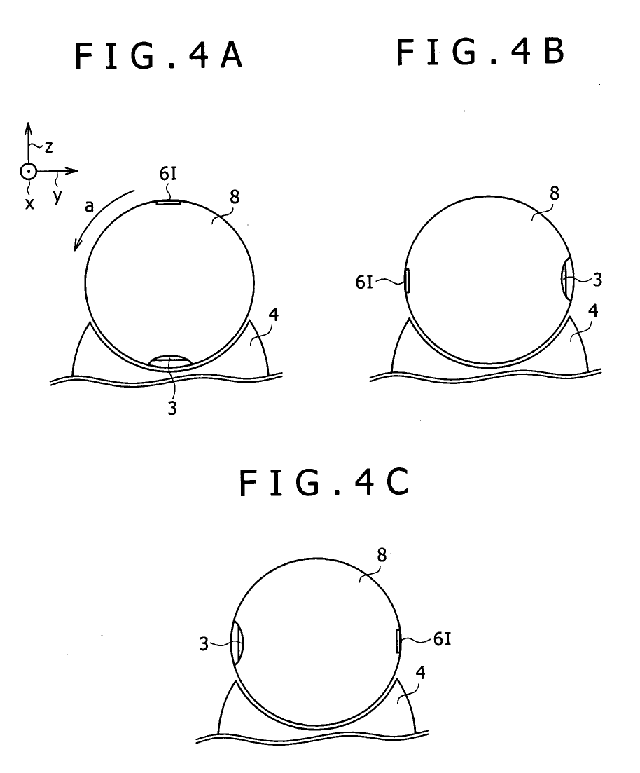

In this case, the camera cover 8 can be rotated in a direction of an arrow “a” or in an opposite direction thereto in a range from a rotation position where the CCD camera 3 is hidden within the LCD cover section 4 as shown in FIG. 4A (this rotation position will hereinafter be referred to as an origin position) to a rotation position where the optical axis of the CCD camera 3 substantially coincides with a direction of a normal to the front surface 2B of the main body part 2 as shown in FIG. 4C (this rotation position will hereinafter be referred to as an end point position).

Thereby, the IC recorder 1 with the camera protects the CCD camera 3 when not used by setting the camera cover 8 in a closed state, in which state the camera cover 8 is positioned at the origin position as shown in FIG. 4A. By changing the camera cover 8 from this state to an open state in which the CCD camera 3 is exposed on the back surface 2A side of the main body part 2 as shown in FIG. 4B by rotating the camera cover 8 in the direction of the arrow “a”, a desired image can be taken while a moving image displayed on the LCD 7 is viewed. By further changing the camera cover 8 from this state by rotating the camera cover 8 to the end point position in the direction of the arrow “a”, the face of a user himself/herself can also be photographed while a moving image displayed on the LCD 7 is viewed, as shown in FIG. 4C.

Incidentally, a macro switch 6I is disposed in the camera cover 8. By setting the macro switch 6I in an on state, a macro mode that can deal with close-up photography in which the CCD camera 3 is close to a subject can be set. In this case, the macro switch 6I is selected to be disposed at a position shifted 180° from that of the CCD camera 3. Thereby, the necessity of the macro mode is determined on the basis of a moving image displayed on the LCD, and when determining that the macro mode is necessary, the user can easily set the macro switch 6I in the on state.

(2) Internal Configuration of IC Recorder 1 with Camera

FIG. 5 shows an internal configuration of the IC recorder 1 with the camera.

When power to the IC recorder 1 with the camera is turned on, the microphones 20A and 20B collect external sound, and send a resulting sound signal S1 to an AD (Analog-Digital)/DA (Digital-Analog) converter 22 via an amplifier 21. The AD/DA converter 22 sequentially subjects the sound signal S1 supplied from the microphones 20A and 20B to a digital conversion process, and sequentially sends resulting sound data D1 to a data processing and controlling unit 23.

The data processing and controlling unit 23 includes: a controlling unit 28 of a microcomputer configuration including a CPU (Central Processing Unit) 24 controlling the IC recorder 1 with the camera as a whole, a ROM (Read Only Memory) 25 storing various programs, a RAM (Random Access Memory) 26 as a work memory for the CPU 24, and a built-in timer 27; and a DSP (Digital Signal Processor) 29 having a function of compressing and decompressing the sound data D1 and image data D3 to be described later.

When one of the recording button 6A, the live view button 6B, the camera shutter button 6C, the menu button 6D, the jog lever 6E, the stop button 6F, the volume button 6G, the voice-up switch 6H, and the macro switch 6I described above that form an operating control section 6 is operated, an operating input signal S2 corresponding to the operation is supplied from the operating control section 6 to the controlling unit 28 of the data processing and controlling unit 23.

The controlling unit 28 is also supplied with an LCD cover state signal S3 indicating the closed state (FIG. 1 and FIG. 2) or the open state (FIG. 3) of the LCD cover section 4 and a camera cover state signal S4 indicating the closed state (FIG. 4A) or the open state (FIGS. 4B and 4C) of the camera cover 8 from a corresponding sensor (not shown) provided within the LCD cover section 4.

Thus, the CPU 24 in the controlling unit 28 recognizes an operation content of a user operation on the basis of the operating input signal S2, and detects present states of the LCD cover section 4 and the camera cover 8 on the basis of the LCD cover state signal S3 and the camera cover state signal S4. The CPU 24 performs corresponding various control processes on the basis of results of the recognition and the detection and various control programs stored in the ROM 25.

In practice, when recognizing that the recording button 6A of the operating control section 6 is pressed on the basis of an operating input signal S2, the CPU 24 determines the states of the LCD cover section 4 and the camera cover 8 on the basis of the LCD cover state signal S3 and the camera cover state signal S4, and when detecting that at least one of the LCD cover section 4 and the camera cover 8 is in a closed state, the CPU 24 correspondingly changes an operation mode to a sound recording mode, and controls the DSP 29. Thus, at this time, the DSP 29 under control of the CPU 24 subjects sound data D1 supplied from the AD/DA converter 22 to an audio compression process in accordance with a predetermined audio compression system such as LPEC (a registered trademark of Sony Corporation) or the like, and sequentially stores resulting compressed sound data D2 in a flash memory 30.

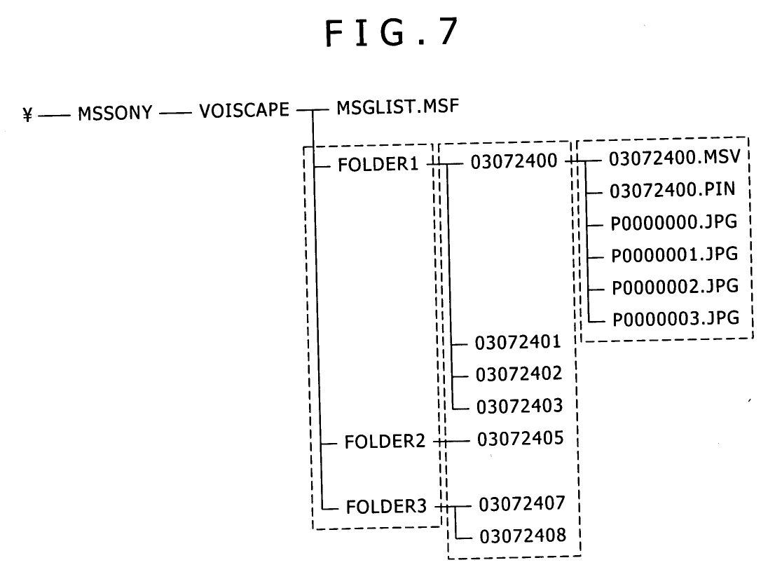

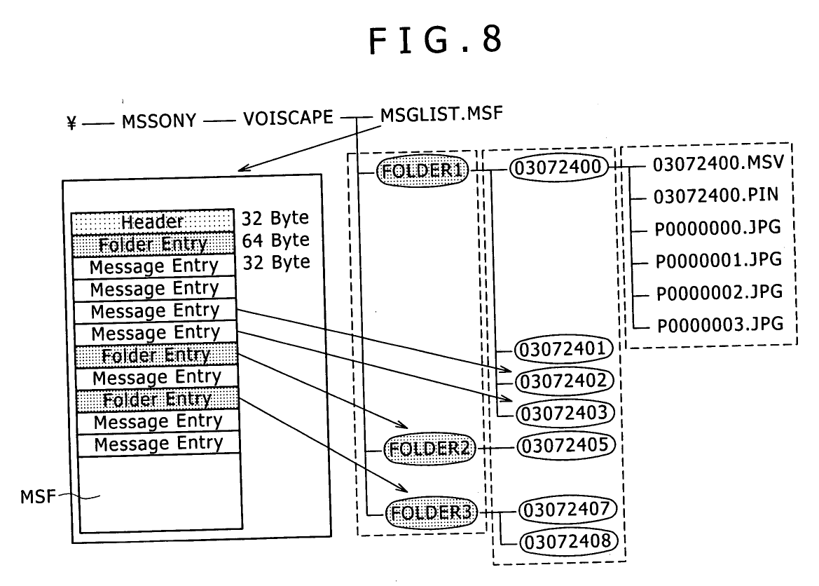

When thereafter recognizing that the stop button 6F is pressed on the basis of an operating input signal S2, the CPU 24 controls the DSP 29 to stop the audio compression process on the sound data D1 supplied from the AD/DA converter 22. Meanwhile, the CPU 24 creates a new message folder (“03072400” to “03072408” in FIG. 7) within a folder selected by the user at that time (“FOLDER1” to “FOLDER3” in FIG. 7). The CPU 24 converts the compressed sound data D2 to a file in the same file format as an audio file format employed in an existing IC recorder. The CPU 24 stores the thus obtained sound file (“03072400.MSV” in FIG. 7) in the message folder. The CPU 24 stores managing information for the message folder in a managing file MSF (FIG. 8) to be described later.

When detecting that both the LCD cover section 4 and the camera cover 8 are in an open state on the basis of the LCD cover state signal S3 and the camera cover state signal S4, the CPU 24 changes the operation mode to a camera mode, and controls the CCD camera 3 to start the CCD camera 3. As a result, an image signal S5 of a scene being photographed by the CCD camera 3 at that time is sequentially output from the CCD camera 3 and supplied to the data processing and controlling unit 23.

Then, when recognizing in this state that the live view button 6B is pressed on the basis of an operating input signal S2, the CPU 24 correspondingly controls the DSP 29. Thus, the DSP 29 at this time sequentially subjects the image signal S5 supplied from the CCD camera 3 to digital conversion, and sends resulting image data D3 to the LCD 7. As a result, a moving image of the scene being photographed by the CCD camera 3 at that time which image is based on the image data D3 is displayed on the LCD 7 in real time.

Further, when thereafter recognizing in this state that the camera shutter button 6C is pressed on the basis of an operating input signal S2, the CPU 24 correspondingly controls the DSP 29. Thus, the DSP 29 at this time captures the image data D3 of a still image for one frame at a moment when the camera shutter button 6C is pressed which image is obtained on the basis of the image data D3, subjects the captured image data D3 to an image compression process in accordance with a predetermined image compression system such for example as JPEG (Joint Photographic Experts Group), and then stores resulting compressed image data D4 in the flash memory 30.

Thereafter the CPU 24 creates a new message folder within a folder selected by the user at that time. The CPU 24 stores an image file of the compressed image data D4 (“P0000000.JPG” to “P0000003.JPG” in FIG. 7) in the message folder. The CPU 24 stores managing information for the message folder in the managing file MSF.

On the other hand, when recognizing that the recording button 6A of the operating control section 6 is pressed on the basis of an operating input signal S2, the CPU 24 determines the states of the LCD cover section 4 and the camera cover 8 on the basis of the LCD cover state signal S3 and the camera cover state signal S4, and when detecting that both the LCD cover section 4 and the camera cover 8 are in an open state, the CPU 24 changes the operation mode to a sound recording and image recording mode, and correspondingly controls the DSP 29.

At this time, as in the above-described sound recording mode, the DSP 29 sequentially subjects sound data D1 supplied from the AD/DA converter 22 to the predetermined audio compression process, and then stores resulting compressed sound data D2 in the flash memory 30. Also, as in the above-described camera mode, the DSP 29 at this time sequentially subjects an image signal S5 supplied from the CCD camera 3 to digital conversion, and sends resulting image data D3 to the LCD 7. As a result, a moving image of a scene being photographed by the CCD camera 3 at that time which image is based on the image data D3 is displayed on the LCD 7 in real time.

Further, when thereafter recognizing in this state that the camera shutter button 6C is pressed on the basis of an operating input signal S2, the CPU 24 correspondingly controls the DSP 29. As in the camera mode, the DSP 29 at this time captures the image data D3 of a still image for one frame at a moment when the camera shutter button 6C is pressed which image is obtained on the basis of the image signal S5 supplied from the CCD camera 3, and subjects the captured image data D3 to an image compression process.

The DSP 29 then stores compressed image data D4 obtained by such an image compression process in the flash memory 30 as compressed image data D4 of an image to serve as a mark for later search for the moment when the camera shutter button 6C is pressed (this image will hereinafter be referred to as a bookmark image) such that the compressed image data D4 is associated with a corresponding position of the compressed sound data D2 being sequentially stored in the flash memory 30 at that time.

When thereafter recognizing that the stop button 6F is pressed on the basis of an operating input signal S2, the CPU 24 creates a new message folder within a folder selected by the user at that time. The CPU 24 stores a sound file of the compressed sound data D2 and image files of compressed image data D4 as described above associated with the sound file in the message folder. The CPU 24 stores managing information for the message folder in the managing file MSF.

Thus, the IC recorder 1 with the camera can not only record sound and still images independently of each other but also record still images as bookmark images in association with sound being recorded.

The IC recorder 1 with the camera enables a search for a desired message folder or a desired sound position within a message folder on the basis of a bookmark image thus recorded in association with sound.

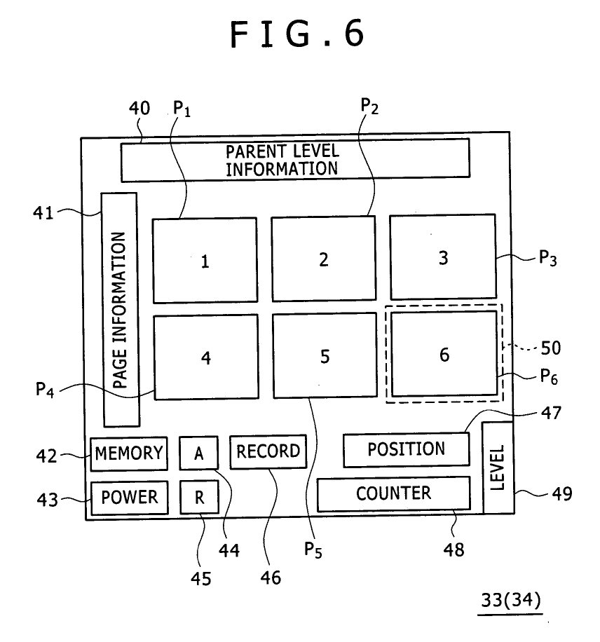

In practice, when the jog lever 6E is pressed and the CPU 24 recognizes on the basis of an operating input signal S2 that a command to display a selecting screen for selecting a desired message folder within a desired folder (this screen will hereinafter be referred to as a message folder selecting screen) or a selecting screen for selecting a desired bookmark image within that message folder (this screen will hereinafter be referred to as a bookmark image selecting screen), the CPU 24 reads corresponding image data D3 from the ROM 25, and then sends the image data D3 to the LCD 7 to thereby display a message folder selecting screen 33 as shown in FIG. 6 or a bookmark image selecting screen 34 (FIG. 6) having a similar composition to that of the message folder selecting screen 33 on the LCD 7.

In this case, to display the message folder selecting screen 33 on the LCD 7, the CPU 24 reads, from the flash memory 30, an image file (compressed image data D4) of a representative bookmark image (hereinafter referred to as a representative image) set in advance for each message folder within the folder, makes the DSP 29 decode the compressed image data D4, and creates thumbnail images P₁ to P₆ of a predetermined size on the basis of resulting image data D3.

Then, as shown in FIG. 6, the CPU 24 displays a list of the thus obtained thumbnail images P₁ to P₆ for the respective message folders within the message folder selecting screen 33. Incidentally, for a message folder including only sound and including no still image, a predetermined icon is displayed instead of a thumbnail image.

When the jog lever 6E is thereafter operated to select one of the thumbnail images P₁ to P₆ within the message folder selecting screen 33, the CPU 24 reads a sound file (compressed sound data D2) within a corresponding message folder from the flash memory 30 on the basis of the above-mentioned managing file MSF (FIG. 8), and then makes the DSP 29 decode the compressed sound data D2.

As a result, sound data D1 obtained by such a decoding process is output from the DSP 29 to be subjected to analog conversion in the AD/DA converter 22. A resulting sound signal S6 is supplied to the speaker 32 via an amplifier 31. Thereby, at this time, sound based on the sound signal S6 is output from the speaker 32.

Similarly, to display the bookmark image selecting screen 34 (FIG. 6) on the LCD 7, the CPU 24 reads, from the flash memory 30, image files (pieces of compressed image data D4) of respective bookmark images within a corresponding message folder on the basis of the managing file MSF, makes the DSP 29 decode the pieces of compressed image data D4, and creates thumbnail images P₁ to P₆ of a predetermined size on the basis of pieces of resulting image data D3. Then, the CPU 24 displays a list of the thus obtained thumbnail images P₁ to P₆ for the respective bookmark images within the bookmark image selecting screen 34.

When the jog lever 6E is thereafter operated to select one of the thumbnail images P₁ to P₆ within the bookmark image selecting screen 34, the CPU 24 reads, from the flash memory 30, compressed sound data D2 after a sound part associated with the original bookmark image of the thumbnail image P₁ to P₆ in a corresponding sound file, and then makes the DSP 29 decode the compressed sound data D2.

As a result, sound data D1 obtained by such a decoding process is output from the DSP 29 to be subjected to analog conversion in the AD/DA converter 22. A resulting sound signal S6 is supplied to the speaker 32 via the amplifier 31. Thereby, based on the sound signal S6, sound after the sound position corresponding to the bookmark image selected by the user in the selected message folder is output from the speaker 32.

Thus, the IC recorder 1 with the camera makes it possible to quickly and easily access a desired message folder or a desired sound position in the message folder on the basis of the representative image of the message folder or each bookmark image within the message folder.

In addition to such a configuration, the IC recorder 1 with the camera allows a new bookmark image to be recorded in a message folder including a sound file at a time of reproducing the sound file, and allows sound to be recorded later in a message folder including only an image file in association with the image file.

In practice, when recognizing that the camera shutter button 6C is pressed on the basis of an operating input signal S2 in a state in which the CPU 24 detects that both the LCD cover section 4 and the camera cover 8 are open on the basis of the LCD cover state signal S3 and the camera cover state signal S4 and a sound file of a message folder selected by the user is reproduced as described above, the CPU 24 correspondingly controls the DSP 29.

Under control of the CPU 24, the DSP 29 at this time captures image data D3 of a still image for one frame at a moment when the camera shutter button 6C is pressed which image is obtained on the basis of an image signal S5 supplied from the CCD camera 3, and subjects the captured image data D3 to an image compression process. The DSP 29 then stores compressed image data D4 obtained by such an image compression process in the flash memory 30 as an image file of a bookmark image at the moment when the camera shutter button 6C is pressed such that the compressed image data D4 is associated with the sound file being reproduced at that time.

On the other hand, when recognizing that the recording button 6A is pressed on the basis of an operating input signal S2 after a message folder including only an image file is selected on the message folder selecting screen 33 (FIG. 6) displayed on the LCD 7 and a command for additional recording in the message folder is input by a predetermined operation using the jog lever 6E, the CPU 24 correspondingly controls the DSP 29.

Thus, under control of the CPU 24, the DSP 29 at this time subjects sound data D1 supplied from the AD/DA converter 22 to an audio compression process, and then stores resulting compressed sound data D2 as a sound file in association with the image file in the flash memory 30. Incidentally, in this case, a still image based on the original image file is automatically set as a bookmark image at a start position of the additionally recorded sound.

Thus the IC recorder 1 with the camera allows a bookmark image to be additionally recorded later freely at a desired position of recorded sound, and allows sound to be additionally recorded later in association with a recorded still image. It is thereby possible to improve ease of search for a desired position of recorded sound and improve functionality of the IC recorder.

(3) Directory Structure of Data Managing Format in IC Recorder with Camera

Description will next be made of a directory structure of a Voiscape Format as a data managing format for compressed sound data D2 and compressed image data D4, which format is employed in the IC recorder 1 with the camera.

FIG. 7 shows the directory structure of the Voiscape Format. As shown in FIG. 7, a sound file (“03072400.MSV”) of recorded sound and image files (“P0000000.JPG” to “P0000003.JPG”) of bookmark images recorded in association with the sound file are stored in a folder referred to as “VOISCAPE” created within a folder referred to as “MSSONY.”

Folders (“FOLDER1” to “FOLDER3”) including message folders are present within this “VOISCAPE.” The user can select a desired folder as a position where a sound file of recorded sound and the like are stored from among these folders, and create a new folder.

“VOISCAPE” also includes the above-described managing file MSF (“MSGLIST.MSF”) for managing the created message folders. As shown in FIG. 8, the managing file MSF has a data structure in which a header (“Header”) of 32 [Bytes] in which a year, a month, and a day, hours, minutes, and seconds, and a day of the week when the managing file MSF was last edited, and the like are described is followed by folder entries (“Folder Entry”) in which folder names and the like of the respective folders (“FOLDER1” to “FOLDER3”) are described, and message entries (“Message Entry”) in which folder names of the respective message folders created within the folders (“FOLDER1” to “FOLDER3”), a data and time of creation of the message folders, and the like are described, the folder entries and the message entries being sequentially described for each folder.

In this Voiscape Format, when a new folder or a new message folder is created, a folder entry or a message entry in which various managing information as described above is described is always registered in the managing file MSF. Thereby the Voiscape Format makes it possible to search surely and quickly for a desired message file within a folder on the basis of the managing file MSF.

Further, each folder (“FOLDER1” to “FOLDER3”) includes one or a plurality of message folders (“03072400” to “03072408”) created according to conditions of use by the user. Each of the message folders includes a sound file (“03072400.MSV”) of compressed sound data D2 obtained by recording, an image file (“P0000000.JPG” to “P0000003.JPG”) of compressed image data D4 of each bookmark image taken during the recording, and an image managing file PIN (“03072400.PIN”) for managing each image file. Incidentally, as described above, the sound file has the same file format as a sound file format employed in an existing IC recorder.

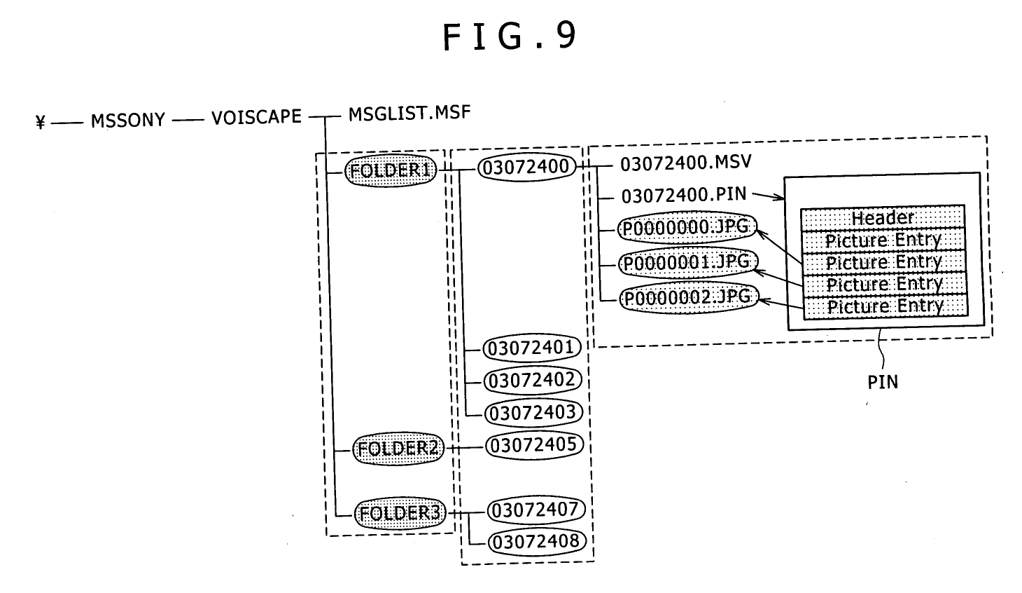

As shown in FIG. 9, the image managing file PIN has a data structure in which a plurality of picture entries (“Picture Entry”) are arranged subsequently to a header (“Header”) in which a year, a month, and a day, hours, minutes, and seconds, and a day of the week when the image managing file PIN was last edited, and the like are described.

In this case, described in a first picture entry are a file name of an image file of a bookmark image when the bookmark image is set as a representative image, a corresponding position (hours, minutes, and seconds) in the sound file (sound data D1) of the bookmark image, and the like. Incidentally, when no representative image is set, zero data is stored in all parts of the first picture entry other than a picture ID, which is described at a start of each picture entry and indicates that a pertinent area is a picture entry.

Described in a second picture entry and subsequent picture entries are file names of image files of respective bookmark images taken during recording of a corresponding sound, corresponding positions (hours, minutes, and seconds) in the sound of the bookmark images, and the like. In this case, the second picture entry or a subsequent picture entry is sequentially added in the rear each time the image file of a new bookmark image is recorded. Hence, an order in which the second picture entry and the subsequent picture entries are arranged in the image managing file PIN represents, as it is, an order of positions with which the image files are associated from a start of the corresponding sound.

Thus, the Voiscape Format makes it possible to search for the representative image of the message folder or a corresponding position in the sound of each bookmark image on the basis of the image managing file PIN. In addition, by thus storing a sound file and an image file of each bookmark image associated with the sound file within a same folder (message folder), relation between the sound file and the image file is easily recognized when these pieces of data are captured into an external personal computer and viewed by Explorer. It is consequently possible to prevent the user from accidentally deleting the sound file or the image file.

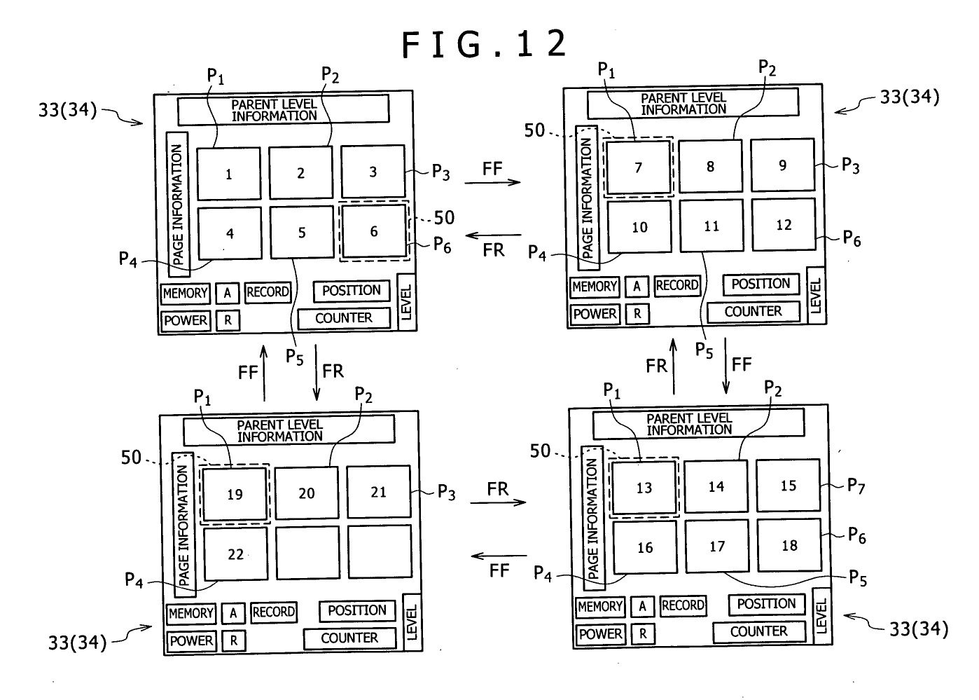

Concrete data structures of the header and a picture entry in the image managing file PIN are shown in FIG. 11 and FIG. 12, respectively.

As is clear from FIG. 11, the header (“HEADER”) in the image managing file PIN includes picture index ID information (“PIND-ID”), version information (“FMT-VER”), manufacturer code information (“MCode”), last edit date and time information (“YMDHMSW”), entry total number information (“ENTRY-NUM”), picture entry size information (“PSIZE”), offset information (“OFFSET”), character code information (“CCODE”), and a reserve (“R”).

In this case, the picture index ID information (“PIND-ID”) represents an ID indicating that the file is an image managing file PIN. A predetermined fixed value is used for the picture index ID information (“PIND-ID”). The version information (“FMT-VER”) indicates a version number of the Voiscape Format, and a corresponding code is stored in the version information.

The manufacturer code information (“MCode”) indicates a manufacturer and a model of a device that last edited the image managing file PIN, and a corresponding code is stored in the manufacturer code information (“MCode”). The last edit date and time information (“YMDHMSW”) indicates a year, a month, and a day, hours, minutes, and seconds, and a day of the week when the image managing file PIN was last edited. The last edit date and time information (“YMDHMSW”) is updated each time a new bookmark image is recorded and a picture entry thereof is added, for example.

The entry total number information (“ENTRY-NUM”) indicates a total number of picture entries registered in the image file (corresponding to a total number of bookmark images included in a corresponding message folder). The entry total number information (“ENTRY-NUM”) is updated each time a new picture entry is registered. The picture entry size information (“PSIZE”) indicates a data size per picture entry in the image managing file PIN. The picture entry size information (“PSIZE”) is described in bytes.

The offset information (“OFFSET”) indicates a start position of a first picture entry by an offset from a start of the image managing file PIN. The offset information (“OFFSET”) is described in bytes. The character code information (“CCODE”) indicates a character code and language used in the image managing file PIN.

As is clear from FIG. 11, a picture entry (“Picture Entry”) in the image managing file PIN includes picture entry ID information (“PID”), image attribute information (“PIA”), corresponding position information (“POSITION”), file name information (“FILE-NAME”), and a reserve (“R”).

In this case, the picture entry ID information (“PID”) represents an ID indicating a start of the picture entry. A predetermined fixed value is stored in the picture entry ID information (“PID”). The image attribute information (“PIA”) indicates that a corresponding bookmark image is a still image obtained by photographing or an icon prepared in advance. When the bookmark image is a still image obtained by photographing, the file name of the image file is stored in the image attribute information (“PIA”). When the bookmark image is an icon prepared in advance, an icon number given to the icon in advance is stored in the image attribute information (“PIA”).

The corresponding position information (“POSITION”) indicates a corresponding position of the corresponding bookmark image in a sound file in the same message folder. The corresponding position information (“POSITION”) describes an amount of an offset from a start of sound based on the sound file in milliseconds. Incidentally, the corresponding position information of a first picture entry is fixed at “O.” The file name information (“FILE-NAME”) indicates the file name of an image file of the corresponding bookmark image.

(4) Method of Operation on Message Folder Selecting Screen 33 or Like

Description will next be made of a method of operation on the message folder selecting screen 33 and the bookmark image selecting screen 34 described with reference to FIG. 6. However, since the methods of operation on the message folder selecting screen 33 and the bookmark image selecting screen 34 are identical, description in the following will be made by taking the message folder selecting screen 33 as an example.

The IC recorder 1 with the camera can be made to display the message folder selecting screen 33 shown in FIG. 6 on the LCD 7 by a predetermined operation as described above.

In this case, the message folder selecting screen 33 includes: a parent level information displaying part 40 for displaying a folder name of a folder in a parent level; a page information displaying part 41 formed by a scroll bar, for example; a memory remaining amount displaying part 42 and a power remaining amount displaying part 43 for displaying a remaining amount of memory of the flash memory 30 and a remaining amount of power supply energy, respectively; an alarm mark displaying part 44 and a repeat mark displaying part 45 for respectively displaying an alarm mark and a repeat mark when a repeat mode is set; a position displaying part 47 for displaying the ordinal position of a message folder that a cursor 50 to be described later indicates among a total number of message folders included in the folder; a counter displaying part 48 for displaying a time that has elapsed from a start of reproduction to a present time while a sound file is reproduced; and a level displaying part 49 for displaying a present level position (a folder level, a message level, or a bookmark level).

Incidentally, the IC recorder 1 with the camera has three kinds of levels, that is, a “folder level,” a “message level,” and a “bookmark level” in descending order of level. Thus, in the case of the message folder selecting screen 33, a folder name of a folder selected at a time in question is displayed in the parent level information displaying part 40. When a level change is made by operating the jog lever 6E, the display screen is changed to a bookmark image selecting screen 34 for a message folder indicated by the cursor 50 at that time. Incidentally, in the case of the bookmark image selecting screen 34, a folder name of the message folder selected at that time is displayed in the parent level information displaying part 40. When a level change is made by operating the jog lever 6E, the display screen is changed to a predetermined folder selecting screen not shown in the figures for selecting a desired folder.

The message folder selecting screen 33 initially displays a list of thumbnail images P₁ to P₆ of bookmark images set in advance as representative images of six message folders having earliest creation dates and times among message folders included in a selected folder, on the basis of the image managing files (“Picture Entry” in FIG. 9) within the message folders in question. At this time, when the message folder does not include image files and includes only a sound file, or the message folder does not have a representative image set therein, for example, a predetermined icon is displayed, as described above.

The cursor 50 is displayed on the message folder selecting screen 33 so as to surround one thumbnail image P₁ to P₆ (this state will hereinafter be referred to as “indicate the thumbnail image P₁ to P₆”). The user can sequentially move the cursor 50 so as to indicate the thumbnail image P₁ to P₆ of a next message folder by pressing the jog lever 6E (FIGS. 1 to 3) to a forward (“FF”) side for a while during reproduction of a sound file or during a reproduction stop. On the other hand, the user can sequentially move the cursor 50 so as to indicate the thumbnail image P₁ to P₆ of a previous message folder by pressing the jog lever 6E to a reverse (“FR”) side for a while during reproduction of a sound file or during a reproduction stop.

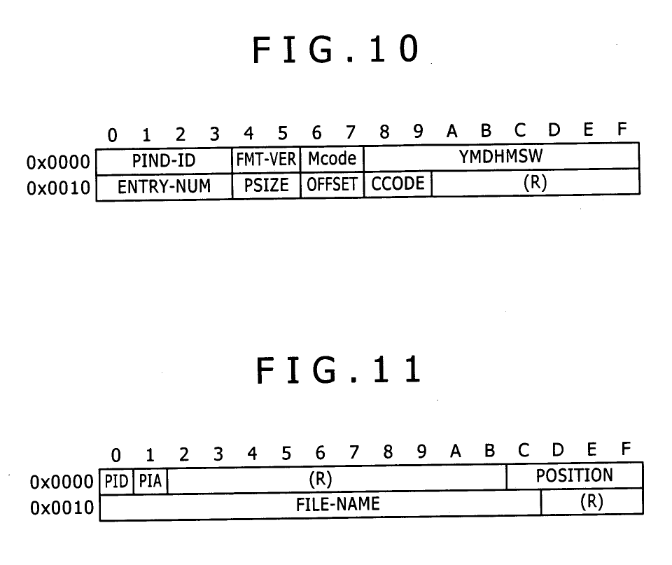

Further, by pressing the jog lever 6E to the forward (“FF”) side for a while in a state in which the cursor 50 indicates the thumbnail image P₆ of a last message folder among the six thumbnail images P₁ to P₆ displayed at that time on the message folder selecting screen 33, a list of the thumbnail images P₁ to P₆ of bookmark images set in advance as representative images of next six message folders included in the folder can be displayed, as shown in FIG. 10.

Similarly, by pressing the jog lever to the reverse (“FR”) side for a while in a state in which the cursor 50 indicates the thumbnail image P₁ of a first message folder among the six thumbnail images P₁ to P₆ displayed at that time on the message folder selecting screen 33, a list of the thumbnail images P₁ to P₆ of bookmark images set in advance as representative images of previous six message folders included in the folder can be displayed, as shown in FIG. 10.

Thus, the user can search for a desired message folder by such an operation of the jog lever 6E on the basis of the thumbnail images P₁ to P₆ displayed on the message folder selecting screen 33. When detecting the message folder, the user moves the cursor 50 so as to indicate the thumbnail image P₁ to P₆ of a representative image of the message folder, and then presses the jog lever 6E to thereby set the message folder as a selected object. As a result, a sound file within the thus set message folder is reproduced, and the reproduced sound is output from the speaker 32 (FIG. 5).

Thus, the IC recorder 1 with the camera makes it possible to search for a desired message folder on the basis of representative images set for respective message folders.

Incidentally, on the message folder selecting screen 33, when the jog lever 6E continues to be pressed to the forward (“FF”) side or the reverse (“FR”) side for a while when reproduction of a sound file is stopped, the cursor 50 is moved at a low speed (for example 0.4 [seconds/message]) for an initial three seconds, at a medium speed (for example 0.2 [seconds/message]) for a next three seconds, and thereafter at a high speed (for example 0.2 [seconds/page (six messages)]), as shown in FIG. 11. However, in switching from a last message folder (a message folder created last) within the folder to a first message folder (a message folder created first) within the folder or in the reverse of the switching, the continuous forward or reverse as described above is stopped, and then the continuous forward or reverse is started all over again (the movement of the cursor is started from the low speed).

Thus, the IC recorder 1 with the camera changes the speed of movement of the cursor 50 according to a state of operation of the jog lever 6E so that the user can access a desired message folder more quickly.

(5) Concrete Process of CPU 24

When the recording button is pressed, the CPU 24 (FIG. 5) of the controlling unit 23 (FIG. 5) makes the IC recorder 1 with the camera perform sound recording operation according to a sound recording control process procedure RT1 represented in FIG. 14 on the basis of a control program stored in the ROM 25 (FIG. 5).

Specifically, when the recording button 6A (FIG. 1) is pressed, the CPU 24 starts the sound recording control process procedure RT1 in step SP0. In next step SP1, the CPU 24 controls the DSP 29 (FIG. 5) to start subjecting sound data D1 output from the AD/DA converter 22 (FIG. 5) at this time to an audio compression process and storing resulting compressed sound data D4 in the flash memory 30 (FIG. 5) (start sound recording operation).

Then proceeding to step SP2, the CPU 24 creates a message folder associated with the compressed sound data D4 stored in the flash memory 30 at this time within a folder (“FOLDER1” to “FOLDER3” in FIG. 7) selected by a user at that time, and registers the message folder in the managing file MSF (FIG. 8). Also, at this time, the CPU 24 creates an image managing file PIN (FIG. 9) within the message folder.

Next, proceeding to step SP3, the CPU 24 determines whether a still image is taken by pressing the recording button 6A (FIG. 1) at this time. When the CPU 24 obtains a negative result in step SP3, the CPU 24 proceeds to step SP6. When the CPU 24 obtains a positive result in step SP3, on the other hand, the CPU 24 proceeds to step SP4, where the CPU 24 controls the DSP 29 to subject an image signal S5 output from the CCD camera 3 at a moment when the recording button 6A is pressed to a digital conversion process and an image compression process, and store resulting compressed image data D4 in the flash memory 30.

Thereafter proceeding to step SP5, the CPU 24 registers managing information for an image file of the compressed image data D4 stored in the flash memory 30 in the image managing file PIN created in step SP2. Thereby a picture entry corresponding to the image file is created in the image managing file PIN. The CPU 24 thereafter proceeds to step SP6.

Proceeding to step SP6, the CPU 24 determines whether the stop button 6D (FIG. 1) is pressed after the start of the sound recording operation. When obtaining a negative result in step SP6, the CPU 24 returns to step SP3 to thereafter repeat a loop from steps SP3 to SP6 to step SP3 until the CPU 24 obtains a positive result in step SP6.

When a user eventually presses the stop button 6D and thus the CPU 24 obtains a positive result in step SP6, the CPU 24 proceeds to step SP7, where the CPU 24 controls the DSP 29 to stop the audio compression process on the sound data D1 output from the AD/DA converter 22 (stop the sound recording operation).

Then proceeding to step SP8, the CPU 24 registers the file size of a message file created at that time in the managing file MSF (FIG. 8). Thereafter the CPU 24 proceeds to step SP9 to end the sound recording control process procedure RT1.

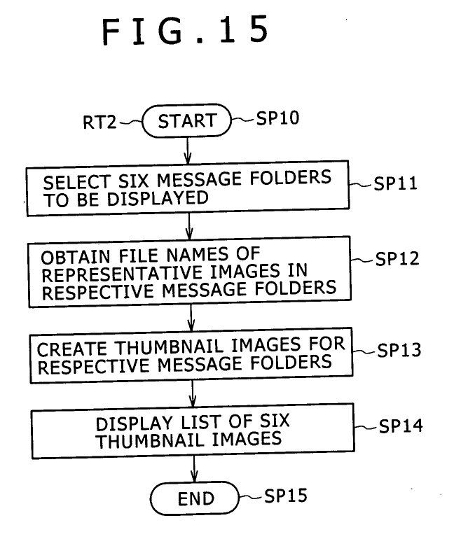

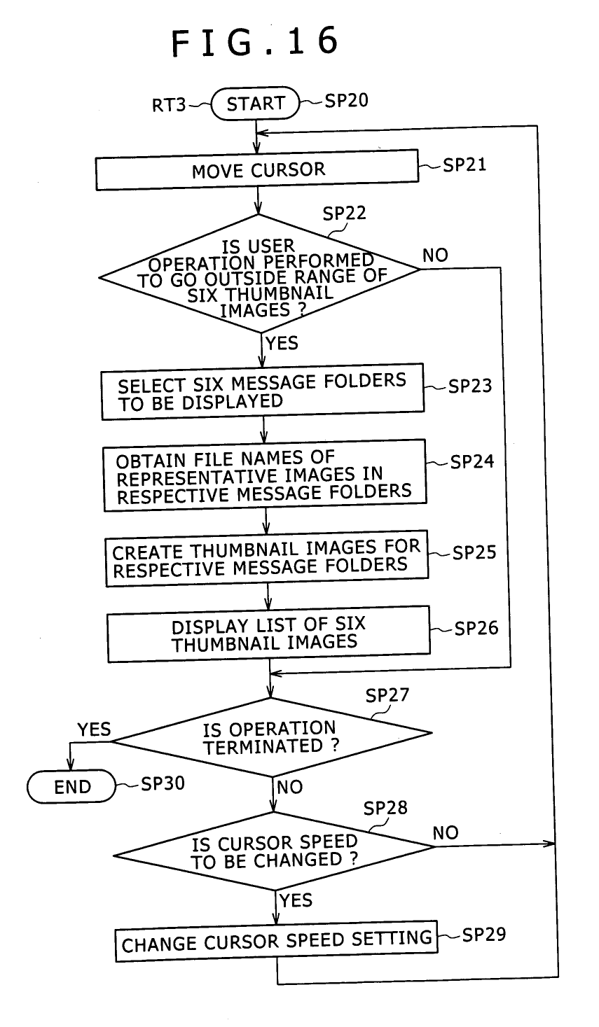

The CPU 24 displays a message folder selecting screen 34 described with reference to FIG. 6 on the LCD 7 (FIG. 1) according to a selecting screen display process procedure RT2 represented in FIG. 15 on the basis of the image managing file PIN (FIG. 9) within each message folder thus created.

Specifically, when supplied with the command to display the message folder selecting screen 33, the CPU 24 starts the selecting screen display process procedure RT1 in step SP10. In next step SP11, the CPU 24 selects six message folders (“03072400” to “03072408” in FIG. 7) having earliest creation dates and times at that time on the basis of the message managing file MSF described above with reference to FIG. 8 stored in the flash memory 30 (FIG. 5).

Next, proceeding to step SP12, the CPU 24 obtains file names of image files of representative images set in the six message folders selected in step SP11 on the basis of image managing files PIN as described above with reference to FIG. 9 within these message folders stored in the flash memory 30.

Thereafter proceeding to step SP13, the CPU 24 reads, from the flash memory 30, data (compressed image data D4) of the image files of the file names obtained in step SP12 for the six message folders selected in step SP11, makes the DSP 29 decode the data, and creates thumbnail images P₁ to P₆ of a predetermined size on the basis of resulting image data D3.

Then proceeding to step SP14, the CPU 24 reads screen data of the message folder selecting screen 33 from the ROM 25 (FIG. 5), generates image data for the message folder selecting screen 33 on which the six thumbnail images P₁ to P₆ are displayed, on the basis of the read screen data and the image data of the thumbnail images P₁ to P₆ for the six message folders which images are created in step SP13, and then sends the image data for the message folder selecting screen 33 to the LCD 7. The message folder selecting screen 33 on which the six thumbnail images P₁ to P₆ are displayed is thereby displayed on the LCD 7.

Thereafter proceeding to step SP15, the CPU 24 ends the selecting screen display process procedure RT1.

When the jog lever 6E (FIG. 1) is thereafter pressed to the forward (“FF”) side or the reverse (“FR”) side, the CPU 24 sequentially updates contents displayed on the message folder selecting screen 33 according to a selecting screen display updating process procedure RT2 represented in FIG. 16 on the basis of a control program stored in the ROM 25 and the image managing file PIN in each message folder.

Specifically, when the jog lever 6E is operated after the selecting screen display process procedure RT2 (FIG. 15) is ended, the CPU 24 starts the selecting screen display updating process procedure RT3 in step SP20. In next step SP21, according to the operation of the jog lever 6E at that time, the CPU 24 sequentially moves the display position of the cursor 50 (FIG. 6) to a corresponding position.

In next step SP22, the CPU 24 determines whether a user operation is performed to go outside the range of the thumbnail images P₁ to P₆ displayed on the message folder selecting screen 33 at that time, that is, determines whether to display the thumbnail images P₁ to P₆ for the next or previous six message folders on the basis of further pressing of the jog lever 6E to the forward (“FF”) side in a state of the cursor 50 indicating the thumbnail image P₆ of a last message folder displayed on the message folder selecting screen 33 at that time or further pressing of the jog lever 6E to the reverse (“FR”) side in a state of the cursor 50 indicating the thumbnail image P₁ of a first message folder displayed on the message folder selecting screen 33 at that time.

Then, when the CPU 24 obtains a negative result in step SP22, the CPU 24 proceeds to step SP27. When the CPU 24 obtains a positive result, on the other hand, the CPU 24 proceeds to step SP23, and then carries out steps SP23 to SP26 in the same manner as steps SP11 to SP14 described above with reference to FIG. 15.

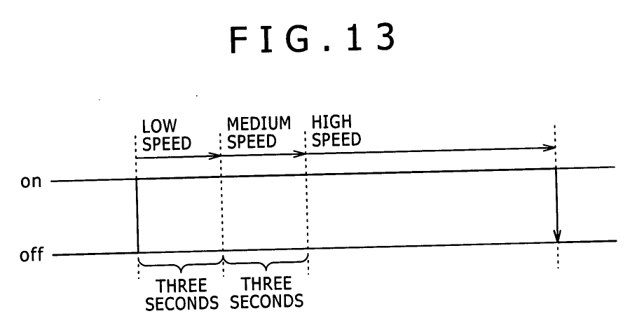

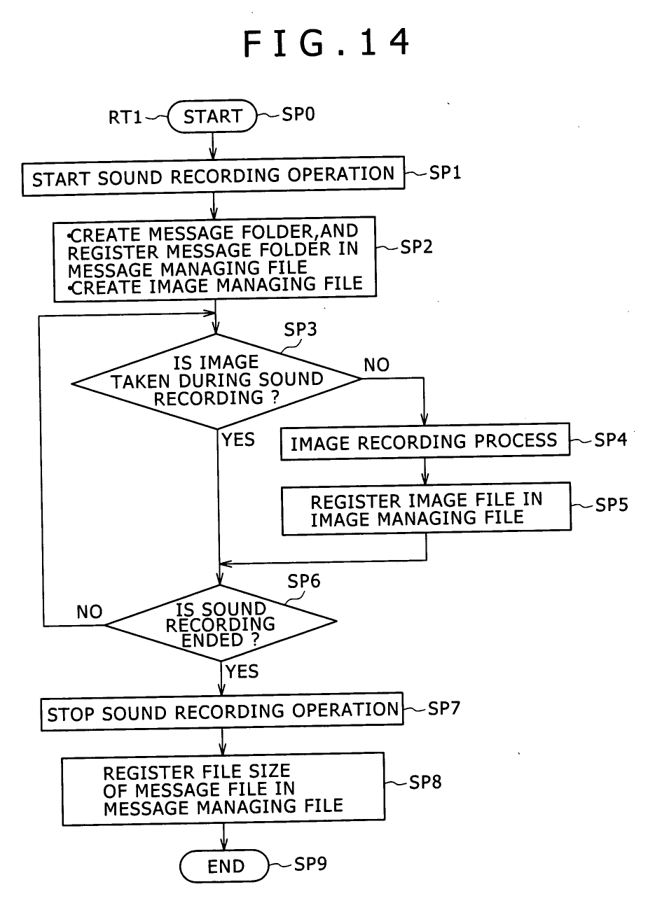

Then, proceeding to step SP27, the CPU 24 determines whether the operation of pressing the jog lever 6E at that time is terminated. When obtaining a negative result, the CPU 24 proceeds to step SP28 to determine whether to change the speed of movement of the cursor 50 from a low speed to a medium speed, from the medium speed to a high speed, or from the high speed to the low speed, as described above with reference to FIG. 13.

When obtaining a negative result in step SP28, the CPU 24 returns to step SP21. When obtaining a positive result in step SP28, the CPU 24 proceeds to step SP29 to change the speed of movement of the cursor 50 at that time to a corresponding moving speed. Then, the CPU 24 returns to step SP21, and thereafter repeats steps SP21 to SP29 until a positive result is obtained in step SP27.

When the operation of pressing the jog lever 6E to the forward (“FF”) side or the reverse (“FR”) side is eventually terminated, and thus the CPU 24 obtains a positive result in step SP27, the CPU 24 proceeds to step SP30 to end the selecting screen display updating process procedure RT3.

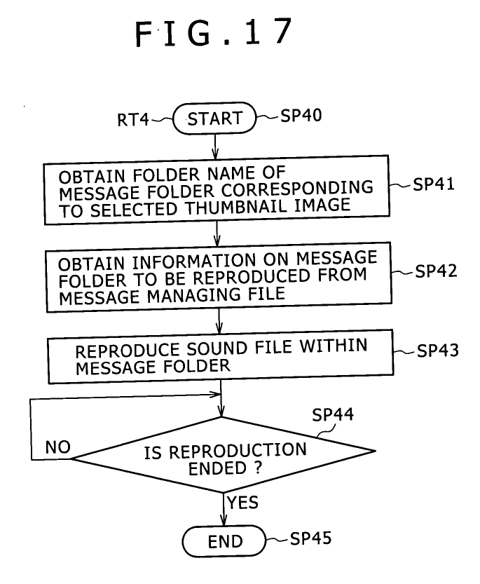

When one message folder is thereafter selected and determined on the message folder selecting screen 33, the CPU 24 reproduces a sound file within the selected and determined message folder according to a sound reproduction process procedure RT4 represented in FIG. 17 on the basis of a control program stored in the ROM 25 (FIG. 5).

Specifically, when one message folder is thereafter selected and determined on the message folder selecting screen 33, the CPU 24 starts the sound reproduction process procedure RT4 in step SP40. In next step SP41, the CPU 24 obtains a folder name of the message folder corresponding to a thumbnail image P₁ to P₆ selected at that time.

Then proceeding to step SP42, the CPU 24 obtains information on the message folder from the managing file MSF described above with reference to FIG. 8 stored in the flash memory 30 (FIG. 5).

Next, proceeding to step SP43, the CPU 24 reads compressed sound data D2 of a sound file included in the message folder from the flash memory 30 on the basis of the information obtained in step SP42, and makes the DSP 29 decode the compressed sound data D2. As a result, sound data D1 obtained by such a decoding process is output from the DSP 29 to be subjected to analog conversion in the AD/DA converter 22 (FIG. 5). The result is supplied as a sound signal S6 to the speaker 32 (FIG. 5). Thereby, sound based on the sound signal S6 is output from the speaker 32.

Thereafter proceeding to step SP44, the CPU 24 waits for the reproduction of the sound file to end. When the reproduction of the sound file eventually ends and thus the CPU 24 obtains a positive result in step SP44, the CPU 24 proceeds to step SP45 to end the sound reproduction process procedure RT4.

(6) Operations and Effects of Present Embodiment

In the above-described constitution, the IC recorder 1 with the camera stores compressed image data D4 of each still image taken during sound recording in association with a sound file of the recorded sound in the flash memory 30. On the other hand, when one folder (“FOLDER1” to “FOLDER3” in FIG. 7) is selected and a command to display the message folder selecting screen 33 is given, the IC recorder 1 with the camera creates thumbnail images P₁ to P₆ of images set as representative images among still images based on compressed image data D4 recorded and stored in association with sound files (message folders) within the folder, and displays a list of the thumbnail images P₁ to P₆ on the message folder selecting screen 33.

When one thumbnail image P₁ to P₆ is thereafter selected from among the thumbnail images P₁ to P₆ displayed in the form of the list on the message folder selecting screen 33, the IC recorder 1 with the camera reproduces a sound file within the corresponding message folder.

In this case, the IC recorder 1 with the camera at a time of sound recording creates an image managing file PIN (FIG. 9) for associating a sound file with an image file in each message folder and sequentially stores necessary information in the image managing file PIN. On the other hand, when one folder is selected and a command to display a message folder selecting screen 33 is given, the IC recorder 1 with the camera displays a list of thumbnail images P₁ to P₆ of representative images of respective message folders on the message folder selecting screen 33 on the basis of the image managing file PIN. When one thumbnail image P₁ to P₆ is selected from among the thumbnail images P₁ to P₆ displayed on the message folder selecting screen 33, the IC recorder 1 with the camera reproduces a sound file stored in a corresponding message folder on the basis of such an image managing file PIN.

Thus, the IC recorder 1 with the camera does not need to employ a special file format as the file format of sound files obtained by sound recording and image files obtained by photographing at the time of sound recording. The IC recorder 1 with the camera can associate the sound files with the image files using files employed in an existing IC recorder. Thus, for example, sound files can be exchanged between the existing IC recorder and the IC recorder 1 with the camera, and the IC recorder 1 with the camera can reproduce a sound file created by sound recording using the existing IC recorder and conversely the existing IC recorder can reproduce a sound file created by sound recording using the IC recorder 1 with the camera.

According to the above constitution, at a time of sound recording, an image managing file PIN (FIG. 9) for associating a sound file with an image file is created in each message folder, and necessary information is sequentially stored in the image managing file PIN. On the other hand, the sound file and the image file are associated with each other on the basis of the image managing file PIN. Thus, it is not necessary to employ a special file format as the file format of the sound file and the image file, and it is possible to associate the sound file with the image file using the file format employed in an existing IC recorder. Thus, an IC recorder with a camera can be realized which can associate sound files with image files while having versatility by maintaining compatibility with sound files obtained by sound recording using an existing IC recorder.

(7) Other Embodiments

It is to be noted that while in the foregoing embodiment, description has been made of a case where the present invention is applied to an IC recorder with a camera formed as shown in FIGS. 1 to 5, the present invention is not limited to this, and is widely applicable to various other portable type recording and reproducing devices.

In addition, while in the foregoing embodiment, description has been made of a case where the image managing file PIN for associating a sound file with an image file is formed as shown in FIGS. 9 to 11, the present invention is not limited to this, and various other formations are widely applicable.

The present invention is widely applicable to not only an IC recorder 1 with a camera but also various other recording and reproducing devices.

It should be understood by those skilled in the art that various modifications, combinations, sub-combinations and alterations may occur depending on design requirements and other factors insofar as they are within the scope of the appended claims or the equivalents thereof.

What is claimed is:

1. A portable type recording and reproducing device comprising:
sound collecting means for collecting external sound, and outputting sound information corresponding to a result of sound collection;
photographing means for photographing an outside, and outputting image information corresponding to a result of photographing;
recording means for converting said sound information output from said sound collecting means to files in message units and recording said files on a predetermined recording medium, and recording said image information output from said photographing means on the recording medium in association with a corresponding file of said sound information in response to a predetermined first external operation;
display means for displaying images based on said image information associated with respective said files of said sound information; and
reproducing means for reproducing said file of said sound information associated with said image selected by a predetermined second external operation among said images displayed by said display means,
wherein said recording means creates an image managing file for associating said sound information with each piece of said image information, and
said reproducing means reproduces said file of said sound information associated with said image selected by the predetermined second external operation among said images displayed by said display means on a basis of said image managing file.

2. The recording and reproducing device as claimed in claim 1, wherein said recording means stores said file of said sound information, a file of said image information associated with said file of said sound information, and an image managing file for associating said file of said sound information with said file of said image information within a same folder.

3. The recording and reproducing device as claimed in claim 1, wherein said image managing file has an area for, when a representative image is set from among said images based on respective pieces of said image information within one or a plurality of image files, identifying the set said representative image.

4. The recording and reproducing device as claimed in claim 3, wherein said display means displays a thumbnail image based on said image information of said representative image set for said file of each piece of said sound information on a basis of said image managing file.

5. The recording and reproducing device as claimed in claim 1, wherein said first external operation is an operation of pressing a camera shutter button.

6. The recording and reproducing device as claimed in claim 1, wherein said second external operation is an operation of moving a cursor displayed together with said images by said display means so that the cursor indicates a desired said image by operating a predetermined operating element, and then setting said image as a selected object by operating said operating element.

7. The recording and reproducing device as claimed in claim 5, wherein said second external operation is an operation of moving a cursor displayed together with said images by said display means so that the cursor indicates a desired said image by operating a predetermined operating element, and then setting said image as a selected object by operating said operating element.

8. A recording and reproducing method comprising:
a first step of converting sound information obtained by collecting external sound to files in message units and recording the files on a predetermined recording medium, and recording image information obtained by photographing an outside on said recording medium in association with a corresponding file of said sound information in response to a predetermined first external operation;
a second step of displaying images based on said image information associated with respective said files of said sound information; and
a third step of reproducing said file of said sound information associated with said image selected by a predetermined second external operation among the displayed said images,
wherein in said second step, an image managing file for associating said sound information with each piece of said image information is created, and
in said third step, said file of said sound information associated with said image selected by the predetermined second external operation among the displayed said images is reproduced on a basis of said image managing file.

9. The recording and reproducing method as claimed in claim 8, wherein in said second step, said file of said sound information, a file of said image information associated with said file of said sound information, and an image managing file for associating said file of said sound information with said file of said image information are stored within a same folder.

10. The recording and reproducing method as claimed in claim 8, wherein said image managing file has an area for, when a representative image is set from among said images based on respective pieces of said image information within one or a plurality of image files, identifying the set said representative image.

11. The recording and reproducing method as claimed in claim 10, wherein in said second step, a thumbnail image based on said image information of said representative image set for said file of each piece of said sound information is displayed on a basis of said image managing file.

12. The recording and reproducing method as claimed in claim 8, wherein said first external operation is an operation of pressing a camera shutter button.

13. The recording and reproducing method as claimed in claim 8, wherein said second external operation is an operation of moving a cursor displayed together with said images by said display means so that the cursor indicates a desired said image by operating a predetermined operating element, and then setting said image as a selected object by operating said operating element.

14. The recording and reproducing method as claimed in claim 12, wherein said second external operation is an operation of moving a cursor displayed together with said images by said display means so that the cursor indicates a desired said image by operating a predetermined operating element, and then setting said image as a selected object by operating said operating element.

15. A portable type recording and reproducing device comprising:
a sound collector collecting external sound, and outputting sound information corresponding to a result of sound collection;
a photographing device photographing an outside, and outputting image information corresponding to a result of photographing;
a recorder converting said sound information output from said sound collector to files in message units and recording said files on a predetermined recording medium, and recording said image information output from said photographing device on the recording medium in association with a corresponding file of said sound information in response to a predetermined first external operation;
a display device displaying images based on said image information associated with respective said files of said sound information; and
a reproducer reproducing said file of said sound information associated with said image selected by a predetermined second external operation among said images displayed by said display device,
wherein said recorder creates an image managing file for associating said sound information with each piece of said image information, and
said reproducer reproduces said file of said sound information associated with said image selected by the predetermined second external operation among said images displayed by said display device on a basis of said image managing file.
